(19) United States
(12) Patent Application Publication
(10) Pub. No.: US 2026/0267802 A1
(43) Pub. Date: Sep. 10, 2026

(54) IC APPARATUS WITH COHERENCY DOMAINS

(71) Applicant: Arm Limited, Cambridge (GB)

(72) Inventors: Sai Kumar Marri, Austin, TX (US); Mark David Werkheiser, Austin, TX (US); Jamshed Jalal, Austin, TX (US); Dimitrios Kaseridis, Austin, TX (US); Ashok Kumar Tummala, Cedar Park, TX (US); Adarsh Nallamur Krishnakumar, Austin, TX (US)

(73) Assignee: Arm Limited, Cambridge (GB)

(21) Appl. No.: 19/548,000

(22) Filed: Feb. 24, 2026

(30) Foreign Application Priority Data
Mar. 5, 2025 (EP) 25300014.5

(51) Int. Cl. G06F 12/0817

(52) U.S. Cl. CPC G06F 12/0828; G06F 2212/621

(57) ABSTRACT

An integrated-circuit apparatus comprises a requestor node and a first plurality of coherency nodes configured to provide a distributed system-level cache, each coherency node being configured to provide system-level caching for a respective set of memory addresses allocated to the coherency node. The first plurality of coherency nodes, or a second plurality of coherency nodes, is configured to provide respective distributed local coherency caches for a set of local coherency domains, wherein each of the coherency nodes of the first or second plurality is configured to provide local coherency caching for a respective set of memory addresses allocated to the coherency node. The apparatus is configured to assign the requestor node and each coherency node to a respective local coherency domain of the set of local coherency domains. The requestor node is configured to send a first memory request to a coherency node, in a same local coherency domain as the requestor node, for local-coherency-cache lookup. The requestor node is further configured to send a second memory request to a coherency node, in a same local coherency domain as the requestor node, for system-level-cache lookup without first sending the second memory request to a coherency node for local-coherency-cache lookup.

### TECHNICAL FIELD

The present disclosure relates to an integrated-circuit (IC) apparatus comprising a plurality of coherency nodes.

### BACKGROUND

An integrated-circuit data processing system, such as a single system-on-chip (SoC) or a plurality of coupled chips or chiplets, can include multiple components coupled by an interconnect as nodes of a network. Such components can include processing devices, storage devices and input-output devices. Requestor nodes (RNs) such as central processing units (CPUs), CPU clusters, graphics processing units (GPUs), GPU clusters, etc. may request data, over the network, from storage nodes (SNs) such as memory controllers coupled to memory of the system. Home nodes (HNs) of the data processing system may act points of coherency for respective cache lines corresponding to respective sets of memory addresses. However, accessing a cache line served by a home node that is far away from the requestor node can lead to high latency.

### SUMMARY

Disclosed herein is an integrated-circuit apparatus comprising a first plurality of coherency nodes configured to provide a distributed system-level cache, wherein each of the plurality of coherency nodes is configured to provide system-level caching for a respective set of memory addresses allocated to the coherency node; and further comprising a requestor node. The first plurality of coherency nodes, or a second plurality of coherency nodes, is configured to provide respective distributed local coherency caches for a set of local coherency domains, wherein each of the coherency nodes of the first or second plurality is configured to provide local coherency caching for a respective set of memory addresses allocated to the coherency node. The apparatus is configured to assign the requestor node and each coherency node to a respective local coherency domain of the set of local coherency domains. The requestor node is configured to send a first memory request to a coherency node, in a same local coherency domain as the requestor node, for local-coherency-cache lookup. The requestor node is further configured to send a second memory request to a coherency node, in a same local coherency domain as the requestor node, for system-level-cache lookup without first sending the second memory request to a coherency node for local-coherency-cache lookup.

Also disclosed herein is a method of operating such an integrated-circuit apparatus, the method comprising: the requestor node sending a first memory request to a coherency node, in a same local coherency domain as the requestor node, for local-coherency-cache lookup; and the requestor node sending a second memory request to a coherency node, in a same local coherency domain as the requestor node, for system-level-cache lookup without first sending the second memory request to a coherency node for local-coherency-cache lookup.

### BRIEF DESCRIPTION OF THE DRAWINGS

Certain embodiments of the disclosure will now be described, by way of example only, with reference to the accompanying drawings, in which:

FIG. 1 is a schematic diagram of part of an integrated-circuit data processing system embodying the present disclosure;

FIG. 2 is a schematic diagram of a network of a chip embodying the present disclosure;

FIG. 3 is a pair tables illustrating target ID lookup logic according to the present disclosure;

FIG. 4 is a flow chart of a method embodying the present disclosure;

FIG. 5 is a schematic diagram of request and snoop flow within a system embodying the present disclosure; and

FIG. 6 is a schematic diagram of a request and snoop being routed between a pair of chiplets each embodying the present disclosure.

### DETAILED DESCRIPTION

Some embodiments provide an integrated-circuit (IC) apparatus comprising:
a first plurality of coherency nodes configured to provide a distributed system-level cache, wherein each of the plurality of coherency nodes is configured to provide system-level caching for a respective set of memory addresses allocated to the coherency node; and
a requestor node (RN);
wherein:
   the first plurality of coherency nodes, or a second plurality of coherency nodes, is configured to provide respective distributed local coherency caches for a set of local coherency domains (LCDs), wherein each of the coherency nodes of the first or second plurality is configured to provide local coherency caching for a respective set of memory addresses allocated to the coherency node;
   the apparatus is configured to assign the requestor node and each coherency node to a respective local coherency domain of the set of local coherency domains;
   the requestor node is configured to send a first memory request to a coherency node, in a same local coherency domain as the requestor node, for local-coherency-cache lookup; and
   the requestor node is further configured to send a second memory request to a coherency node, in a same local coherency domain as the requestor node, for system-level-cache lookup without first sending the second memory request to a coherency node for local-coherency-cache lookup.

The requestor node (RN) and coherency nodes may be nodes of a network. They may be coupled by an interconnect. The network may comprise one or more further RNs, each of which may be similarly configured. The IC apparatus may be a single chip or it may comprise a plurality of chips or chiplets, which may each comprise nodes that are coupled by a network.

Each coherency node may be configured to provide a respective point of coherency, within the IC apparatus (e.g. within a network), for the respective set of memory addresses. Each set of memory addresses may correspond to a respective set of cache lines. Each coherency node may be further configured to provide a point of serialization. Each coherency node may be coupled to a different respective port of a router (e.g. XP) of the IC apparatus.

In embodiments in which there is a second plurality of coherency nodes, the first plurality of coherency nodes may be a plurality of fully coherent Home Nodes (HNFs), and the second plurality of coherency nodes may be a plurality of local coherency nodes (LCNs).

In embodiments in which there is no second plurality of coherency nodes, the first plurality of coherency nodes may be a plurality of super home nodes (HNSs). Each node may be configured to implement both HNF functionality and LCN functionality. Each node may be configured to provide system-level caching for a respective first set of memory addresses and to provide local-coherency caching for a respective second set of memory addresses. The respective first and second sets may be different. However, for at least one or more of the coherency nodes, they may be overlapping (i.e. having at least one memory address in common).

The RN (or each RN if more than one is provided) may be configured to determine whether a memory request (e.g. each of the first and second memory requests) is for a memory address that is allocated to a coherency node for system-level caching that is in a same local coherency domain as the RN, and may be configured to send a memory request (e.g. the second memory request) to the coherency node for system-level-cache lookup, without first sending the memory request for local-coherency-cache lookup, in response to determining that the memory request satisfies a proximity condition—e.g. when the coherency node for system-level-cache lookup is relatively close to the RN.

The RN (or each RN if more than one is provided) may be configured to determine whether a memory request (e.g. each of the first and second memory requests) is for a memory address that is allocated to a coherency node for system-level caching that is in a same local coherency domain as the RN, and may be configured to send a memory request (e.g. the second memory request) to the coherency node for system-level-cache lookup, without first sending the memory request for local-coherency-cache lookup, in response to determining that the memory request is for a memory address that is allocated to a coherency node for system-level caching that is in a same local coherency domain as the RN.

In some embodiments, each coherency node provides system-level caching and local coherency caching (e.g. is an HNS), and the RN (or each RN is more than one is provided) is configured to determine whether a memory request is for a memory address that is allocated to a coherency node, in a same local coherency domain as the RN, for local-coherency caching and for system-level caching. The RN may be configured to send the memory request to the coherency node (e.g. HNS) for system-level-cache lookup, without first sending the memory request for local-coherency-cache lookup, in response to determining that the memory request is for a memory address that is allocated to a coherency node, in a same local coherency domain as the RN, for local-coherency caching and for system-level caching.

The RN may be configured to set a flag within the memory request to indicate whether the memory request is to be processed by the coherency node for system-level-cache lookup or for local-coherency-cache lookup. Each coherency node (e.g. HNS) may be configured to determine whether to process a received memory request for system-level-cache lookup or for local-coherency-cache lookup in dependence upon the flag. The flag may be a multi-bit flag or a single bit, e.g. a predetermined position within each memory request.

Each of the coherency nodes that are configured to provide local-coherency caching (e.g. HNSs or LCNs) may be further configured, in response to a cache-line miss for a respective memory request received for local-coherency-cache lookup, to send the memory request to a coherency node for system-level-cache lookup (e.g. to another HNS or an HNF). Each of the coherency nodes may be configured (e.g. in response to a local cache miss) to set a flag, or the flag, within the memory request to indicate that the memory request is to be processed for system-level-cache lookup.

Each of the coherency nodes may be associated with a respective node identifier. The RN may be configured to determine, from any of a set of memory addresses, a respective first node identifier for system-level-cache lookup and a respective second node identifier for local-coherency-cache lookup. The RN may be configured to use the respective first and second node identifiers determined from a memory address to determine whether to send a memory request for the memory address to a coherency node for system-level-cache lookup without first sending the memory request for local-coherency-cache lookup.

The RN may be configured, when determining the first node identifier, to apply a first hash function to the memory address, and may be configured, when determining the second node identifier, to apply a second hash function, different from the first hash function, to the memory address. The second hash function may produce results of a first bit length and the second hash function may produce results of a second bit length shorter than the first bit length. A result of the first or second hash may be used (e.g. as an offset) to look up the respective node identifier in a lookup table. The lookup table may be stored on the IC, e.g. being hardwired or stored in a memory. A respective copy of all or a respective portion of the table may be stored by the, or each RN. The same lookup table may be used by the RN for both determinations. A base offset may be added to a result of the second hash function, wherein the base offset depends on an identity of a local coherency domain to which the RN is assigned (i.e. which LCD the RN is in).

In addition the RN, each of the coherency nodes may be configured to determine the respective second node identifier from any of a set of memory addresses. Each coherency node may do so using the same second hash function. Each may store a respective copy of all or a respective portion of the table. Each coherency node may be configured to direct a snoop, associated with a memory address, to a coherency node associated with the respective second node identifier.

The IC apparatus may comprise one or more memory-controller or bridge nodes (e.g. SNs), each associated with a respective node identifier. The RN may be further configured to determine, from any of the set of memory addresses, a respective third node identifier, and may be configured to send a direct-access or prefetch request for a memory address to a memory-controller or bridge node associated with the respective third node identifier without first sending the request to a coherency node.

The apparatus may be configured, for each of the local coherency domains, to track RNs, associated with memory requests, in a respective local-coherency-cache snoop filter for the local coherency domain, and may be further configured to track local coherency domains, associated with memory requests, in a system-level-cache snoop filter. It may be configured to use this information to route snoops to RNs.

The requestor node and first plurality of coherency nodes may be provided by a first integrated-circuit chip, which may comprise a plurality of cross-chip gateway-port aggregation groups for communication with one or more further integrated-circuit chips (which may be part of or distinct from the IC apparatus). Each of the local coherency domains may be affinitized to a closest cross-chip gateway-port aggregation group of the plurality of cross-chip gateway-port aggregation groups. This can improve routing efficiency.

The assignment of the RN and each of the coherency nodes to a respective local coherency domain may be configurable. It may depend at least in part upon configuration data stored in a configuration memory of the apparatus. The configuration data may be fused at production or may be writeable by software executing on the IC apparatus. In some embodiments, the assignment may be updatable at boot time. A total number of local coherency domains provided by the apparatus in operation may be configurable and may depend at least in part upon the configuration data stored in the configuration memory.

A method of operating an IC apparatus as disclosed herein may comprise the RN sending a first memory request to a coherency node, in a same local coherency domain as the RN, for local-coherency-cache lookup; and the RN sending a second memory request to a coherency node, in a same local coherency domain as the RN, for system-level-cache lookup without first sending the second memory request to a coherency node for local-coherency-cache lookup.

The RN may determine that the first memory request is for a memory address that is allocated to a coherency node for system-level caching that is not in a same local coherency domain as the RN, and performing the sending of the first memory request for local-coherency-cache lookup in response thereto. The RN may determine that the second memory request is for a memory address that is allocated to a coherency node for system-level caching that is in a same local coherency domain as the RN, and performing the sending of the second memory request for system-level-cache lookup in response thereto.

Each coherency node may provide system-level caching and local coherency caching (e.g. being an HNS), and the method may further comprise the RN determining that the first memory request is for a memory address that is allocated to a first coherency node, in a same local coherency domain as the RN, for local-coherency caching and that is allocated to a second coherency node, different from the first coherency node, for system-level caching, and performing the sending of the first memory request for local-coherency-cache lookup in response thereto. It may comprise the RN determining that the second memory request is for a memory address that is allocated to a coherency node, in a same local coherency domain as the RN, for local-coherency caching and for system-level caching, and performing the sending of the second memory request for system-level-cache lookup in response thereto.

Each of the coherency nodes may be associated with a respective node identifier, and the method may further comprise the RN determining, from the memory address of the first memory request, a first node identifier for system-level-cache lookup and a second node identifier for local-coherency-cache lookup; determining that the second node identifier does not equal the first node identifier; and, in response thereto, sending the first memory request to the coherency node associated with the second node identifier for local-coherency-cache lookup. It may comprise the RN determining, from the memory address of the second memory request, a third node identifier for system-level-cache lookup and a fourth node identifier for local-coherency-cache lookup; determining that the third node identifier equals the fourth node identifier; and, in response thereto, sending the second memory request to the coherency node associated with the third node identifier for system-level-cache lookup without first sending the second memory request for local-coherency-cache lookup.

The method may further comprise a coherency node receiving a snoop, associated with the memory address of the first memory request; determining the second node identifier from the memory address; and directing the snoop to the coherency node associated with the second node identifier.

A non-transitory computer-readable medium may store computer-readable code for fabrication of any integrated-circuit apparatus or portion thereof as disclosed herein.

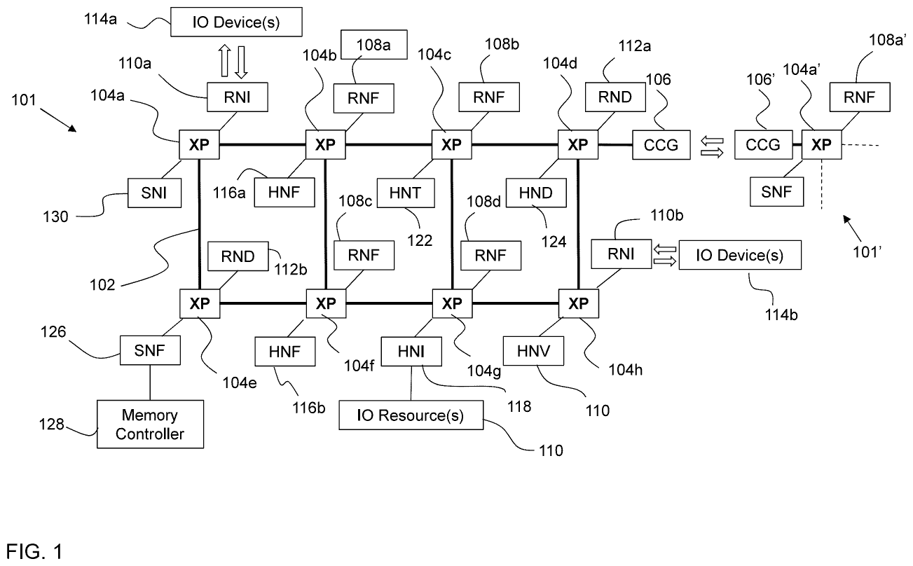

FIG. 1 shows part of an exemplary integrated-circuit data-processing system 101 (e.g. a system-on-chip). The system 101 includes an interconnect 102 comprising a rectangular array of set of routers 104, here labelled as cross-points (XP), coupled by physical channel links. The links provide horizontal (X-axis) and vertical (Y-axis) connections between adjacent XPs 104. The rectangular layout is a logical layout and is not necessarily reflected in the physical placement of the routers and other components on the integrated circuit, although it may be in some embodiments.

The integrated circuit data processing system 101 includes a plurality of nodes. The nodes are coupled together by the interconnect 102, thus forming a connection between the functional blocks which the nodes provide. The interconnect 102 provides signal connections between the nodes and may have various topologies. The interconnect 102 in FIG. 1 has a rectangular mesh topology, but in other variants it may be configured to form a mesh network, a ring network, a cross-bar network, or other network. The interconnect provides a number of cross-points (XPs) 104a-104h. Each cross-point 104a-104h provides one more device ports for coupling to nodes (e.g. to request nodes and home nodes as described below) and one or more network ports which couple to other respective cross-points.

Each router 104 is a multi-channel router. In some examples, flits transmitted through the interconnect 4 are able to be sent on four or more channels provided by the interconnect 102—e.g. a Request Channel (REQ), a Response Channel (RESP), a Data Channel (DAT), and a Snoop Channel (SNP). Each of these (or only some, e.g. RESP and DAT) may be duplicated in order to provide separate channels for transmit (TX) and receive (RX). The REQ channel is used for sending read and write requests, cache maintenance requests, and Distributed Virtual Memory (DVM) requests. The RESP channel is used to send completion responses for various types of messages, ranging from write and cache management responses to data-less snoop responses and operation completion acknowledgments. The SNP channel issues snoops and sends DVM operations. The DAT channel is used to send write and read data, and snoop responses which include data.

Protocol messages are sent in the form of a flit. Flits are a packetized collection of control fields and identifiers that communicate a protocol message.

Some of the control fields sent in a flit include opcodes, memory attributes, address, data, and error responses. Each channel may use different flit control fields. For example, a flit to read or write on the Request channel uses an Address field, and a flit on the Data channel uses the Data and Byte Enable fields. The fields in a flit may be sent in parallel (i.e. not serialized over multiple packets).

There are three categories of node which may be present in the integrated circuit data processing system 101—these are Request Nodes (RNs), Home Nodes (HNs) and subordinate nodes (SNs). Each of these is described further below.

Chip-to-chip gateways (CCGs) can couple between a network on one chip or chiplet (i.e. one integrated circuit data processing system 101) and a similar network on another chip or chiplet (i.e. a second integrated circuit data processing system 101′). This enables formation of a network spanning multiple chips or c. Two example chip-to-chip gateways 106, 106′ belonging respectively to the first and second integrated circuit data processing systems 101, 101′ are shown in FIG. 1, connecting an XP 104d of the first integrated circuit data processing system 101 to an XP 104a′ of a second integrated circuit data processing system 101′. Only a small part of the second integrated circuit data processing system 101′ is shown. Set of CCGs may be grouped together in cross-chip-gateway port aggregation groups (CPAGs).

In this example, CCG nodes 106, 106′ include both a request agent (RA), for issuing requests and receiving snoops, and a home agent (HA), for receiving requests and issuing snoops.

The role of request nodes is to generate transactions, such as read and write requests, in order to access and process data. These transactions are sent to Home Nodes (HNs).

There are several different varieties of request node, each of which is described by a corresponding term—a Fully Coherent Request Node (RNF), an input/output (I/O) Coherent Request Node (RNI), and an I/O Coherent RN with Distributed Virtual Memory (DVM) support (RND). A request node may be, for example, a central processing unit (CPU) core, a neural engine or other accelerator, or a Component Aggregation Layer that houses two or more CPU cores to be connected to one network port.

A Fully Coherent Request Node (RNF) contains coherent caches and will accept and respond to snoop messages for accessing or changing the coherency state of cached data. It will be understood that coherency refers to ensuring that all processors in the system see the same view of memory, meaning that changes to data held in the cache of one core are visible to the other cores, making it impossible for cores to see stale copies of data (the old data from before it was changed by the first core).

An I/O-Coherent Request Node (RNI) does not have a coherent cache, and cannot accept snoop messages. An I/O-Coherent Request Node with DVM support (RND) has the same functionality as an RNI and can also accept DVM messages. Example RNFs 108a-108d, 108a′, RNIs 110a, 110b, and RNDs 112a, 112b, are illustrated in the integrated circuit data processing system 101 of FIG. 1. As illustrated, the RNIs are connected to one or more IO devices 114a, 114b. Although not illustrated, it will be understood that the RNDs 112a, 112b, may also be connected to one or more IO devices.

Home Nodes (HNs) receive transactions from Request Nodes (RNs), and are responsible for ordering these requests, generating transactions to SNs (discussed below) and in some cases issuing snoops and handling DVM operations. There are two main types of home node—fully coherent Home Nodes (HNFs), which order all requests to coherent memory and issue snoops to RN-Fs, and non-coherent Home Nodes (HNIs) which order requests that target an I/O subsystem. Both types act as a point of serialization.

The integrated circuit data processing system 101 includes a system level cache (SLC) which may reduce the number of accesses to memory and reduce the latency of data accesses. The system level cache may be distributed across a large set of home nodes in a network to share the cache capacity over all network nodes across multiple chips, in particular across the fully coherent home nodes (HNFs). The portion of a system level cache (SLC) present at a particular HNF may be referred to as a system cache group (SCG). A fully coherent home node (HNF) provides a point of coherency for a respective subset of system addresses and provides a cache for storing data associated with the addresses. Coherency may be provided by a snoop filter (SF) that tracks data copied to caches in the network caches. HNFs may thus comprise a system cache group (part of the system level cache) and a snoop filter. Thus, HNFs control coherency among data stored by the data processing system. Two example HNFs 116a, 116b are shown in FIG. 1, along with an example HNI 118, which is connected to one or more I/O resources 110.

There are further types of home node which are variations of the HNIs having additional functionality compared to an HNI—these include HNVs, HNTs, and HNDs. An HNV is an HNI which further includes a distributed virtual memory (DVM) node. An HNT is an HNI further including the functionality of both a DVM node and also a Debug Trace Controller (DTC). An HND is HNI further including the functionality of a DVM node, a DTC, and a configuration subordinate (which is a subordinate interface for configuration register space access). FIG. 1 shows an example HNV 110, HNT 122 and HND 124.

A distributed virtual memory (DVM) node, also referred to as a DN, controls its own respective DVM domain, such that each RNF sends its DVM requests to the DN in its own domain. DVM requests are messages that request a DVM operation in order to support maintenance of the virtual memory system. The DN propagates snoops and receives corresponding responses, based on the received DVM request.

Subordinate nodes (SNs) provide access to data sources and sinks, such as memory and peripheral devices. A memory or peripheral device may be located off-chip or on-chip (i.e. as part of the integrated circuit data processing system 101, or separate from it).

There are two types of subordinate node: fully coherent subordinate nodes (SNFs) which connect to memory devices that back the coherent memory space, and non-coherent subordinate nodes (SNIs) which connect to I/O peripherals or non-coherent memory. FIG. 1 shows an example SNF 126, connected to a memory controller 128, and an example SNI 130, which may be connected to non-coherent memory or an I/O peripheral.

Every component in the system is assigned a unique node identifier (ID). The system uses a System Address Map (SAM) to convert physical addresses to node IDs. The SAM can be stored locally across RNs and HNs, which use it to determine a target ID for sending requests and snoops to a targeted node. These identifiers can be used by the XPs 104 for routing flits through the network. In some embodiments, the node identifiers are stored in tables corresponding to the category of node (HNF, etc.) and a hash algorithm (e.g. power-of-two or modulo hashing) is applied to a memory address in order to determine an integer offset for a lookup into the table to find the node ID corresponding to that memory address.

In addition to RN-level caching and system-level caching, embodiments of the present disclosure also provide local-level caching. This is implemented by allocating RNs and HNs to any of a number of local coherency domains (LCDs). Each LCD provides a local coherency cache, spanning the system address space, for use by RNs allocated to that LCD. The LCD functionality is distributed across a set of local coherency nodes (LCNs) within the LCD, each of which provides a point of coherency for a respective set of cache lines (i.e. for a respective set of memory addresses). An RN that has a cache miss on its internal cache can then request a local-coherency-cache lookup from its LCD, rather than having to move straight to a system-level-cache lookup from an HN that may be remote from the RN (e.g. being physically far away on the same chip or on a different chip or chiplet). This can reduce latency.

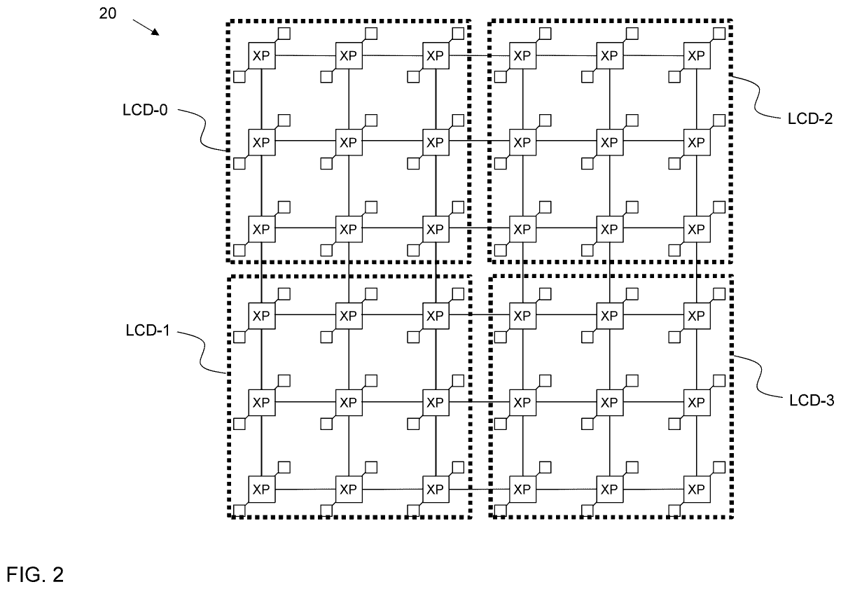

FIG. 2 shows part of an exemplary chip 20 that contains four LCDs, each containing nine XPs and eighteen nodes. Each LCD may include a mixture of RNs, HNs and SNs. The number of LCDs and the allocation of nodes to LCDs may be configurable, e.g. being fused at production time, or being configured by software at boot time. The allocation of nodes may be uniform or non-uniform across the LCDs. Each LCD may correspond to a respective contiguous area of the interconnect, such that devices within the same LCD are likely to be relatively close together physically and/or in communication latency. In particular, each LCD may be confined to one respective chip or chiplet—i.e. not spanning multiple chips or chiplets.

In some embodiments—especially, although not exclusively, in multi-chip systems—the HNFs are implemented as super home nodes (HNSs). These have dual functionality, acting as an HNF for local coherent memory and as a local coherency node (LCN) for remote coherent memory. An HNS allows caching of remote addresses which allows local sharing without going off-chip.

The node ID of an HNS can be obtained in either of two ways: as the result of an HNF lookup, or as the result of an LCN lookup.

The system address map (SAM) at a requestor node (RN) distributes requests across local coherency nodes (LCNs) based on the local coherency domain (LCD) definition and further distributes across home nodes (HNs) based on the system-level definition. As explained in more detail below, a snoop filter at the system level cache (SLC) tracks the multiple local coherency domains (LCDs) in the system and a snoop filter at each local coherency cache tracks the individual requestors (RNs) within this hierarchy. For a given snoop address and node identifier, the SAM determines the corresponding local coherency domain (LCD) and further determines the local coherency node (LCN) based on how cache-lines are distributed in the LCD.

When an RN issues a request to an HNS, it can indicate in the request whether the request should be processed for local-coherency-cache lookup (i.e. by the LCN component of the HNS node) or for system-level-cache lookup (i.e. by the HN component within the HNS node).

Every request is first directed to the LCN for local-coherency-cache lookup. If the cache-line misses at local-coherency-cache, it is then directed, by the LCN, to the appropriate HN for system-level-cache lookup. Every CPU request targeting an HNS contains a hint bit for defining whether the request should be processed by the LCN or the HN within the HNS node.

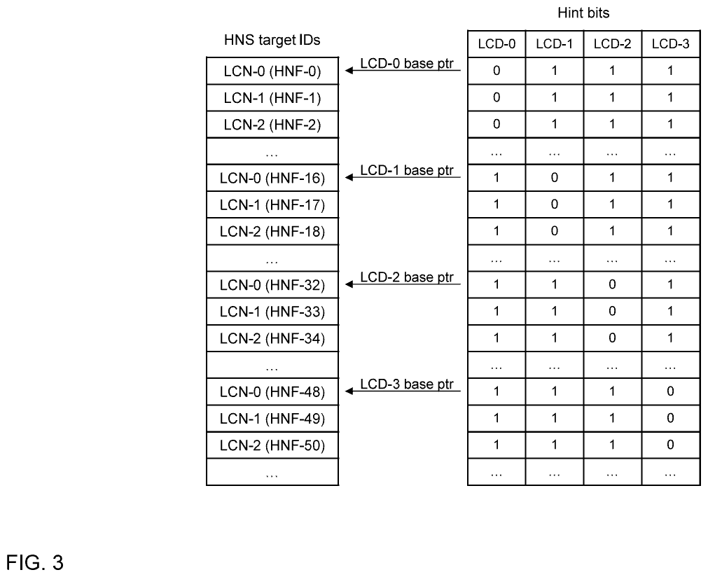

FIG. 3 shows, on the left side, a SAM table layout for storing HNS node IDs for an example system containing four LCDs each containing sixteen HNFs (i.e. sixty-four HNFs in total). Each of the 64 entries in the table will contain a respective HNS node ID, which corresponds to an HNF lookup with an index in the interval [0, 63] and which corresponds to an LCN lookup with an index in the interval [0, 15] for a particular LCD (i.e. with the index offset by a respective LCD base pointer value).

The SAM in some embodiments according with the disclosure includes a flexible hashing scheme to derive the LCN target ID for the local coherency cache hierarchy and the HN target ID for the system level cache, along with which value to set the hint bit to for efficient cache lookups. In particular, rather than always performing a local-cache lookup before every system-level-cache lookup, an RN may bypass the local-cache lookup when a proximity condition is satisfied.

For a given request for a memory address, the SAM in RNs and HNFs can generate three target IDs from the single memory address by applying hashes and lookups:
1) an HNS (LCN) target ID for the distributed local coherency cache hierarchy
2) an HNS (HNF) target ID for the distributed system level cache hierarchy
3) an SN target ID for direct slave access and prefetch requests.

The RN will pick the corresponding target ID based on the type of request and whether a bypass is indicated or not (e.g. whether a proximity condition is satisfied).

In a first set of embodiments, the proximity condition is such that it is satisfied whenever a memory address (cache line) for a request from an RN is allocated to the same HNS for system-level caching as it is allocated to for local-coherency caching within the LCD of the RN. This introduces no additional latency by performing the bypass since the system-level cache lookup is sent to the very same node that would have received the local-level cache lookup had one been sent. Performing the bypass is beneficial whenever there would have been a miss of a local cache lookup, had the bypass not been performed.

The SAM in an RN can test for this first proximity condition by performing two orthogonal hash functions to calculate LCD and HNF index offsets, and then using these to lookup into the common HNS target ID structure (e.g. as shown in FIG. 3) to determine the actual HNS target IDs for local-and system-level caching of that memory address for the LCD of the RN. The RN may then check whether the HNS (LCN) target ID equals the HNS (HNF) target ID, and set the hint bit to one (indicating LCN bound) if they are not equal, and set the hint bit to zero (indicating HNF bound—i.e. bypassing the local-coherency-cache lookup) if they are equal.

In a second set of embodiments, the proximity condition is such that it is satisfied whenever a memory address (i.e. cache line) for a request is allocated to an HNS for system-level caching that is in the same LCD as the RN. This is a looser condition than in the first set of embodiments—i.e. it is expected to result in bypasses being performed more often. However, the HNS is still likely to have a relatively proximate (i.e. low-latency) coupling to the RN (e.g. at least being on the same chip or chiplet), and so the bypass is unlikely to introduce much additional latency, while again avoiding the risk of requiring an additional lookup if a local cache lookup would have missed.

In some embodiments, a bypass is always performed when the first, narrower proximity condition is satisfied, and the system may be selectively configured (e.g. by a boot-time setting) either to additionally perform a bypass when the second, broader proximity condition is satisfied, or not to do so.

FIG. 3 shows logic, implemented by the SAM in each RN, for implementing the second, looser proximity condition. The table on the right of FIG. 3 aligns horizontally with the left table and shows, for each HNS, what value an RN in a particular LCD should set for the corresponding hint bit, when sending a request to that HNS—i.e. whether to instruct local-cache lookup or system-level-cache lookup. The logic in this example is such that a system-level lookup is instructed whenever the HNS for system-level lookup is located in the same LCD as the RN.

In some embodiments, RNs can also be configured to bypass the LCN target ID and can route directly to the HN when processing non-coherent requests (e.g. I/O-traffic)—i.e. where no local caching is available.

A snoop filter in a given cache hierarchy tracks the immediate upper hierarchy requestors. The snoop filter in the system level cache hierarchy tracks all the LCDs, while a snoop filter in each LCD tracks all the individual requestors (RNs) in this hierarchy.

Since all the LCDs represent the same address space, each LCD should be uniquely identified by a caching agent for effective routing of snoops. Within an LCD, a cache line belongs to only one local coherency node (LCN). Routing of snoops from the system level cache hierarchy to the local coherency cache hierarchy is achieved by the HNs performing the same hashing mechanism as is used for routing the requests from the RNs to the local coherency cache hierarchies. In this way, an HN can identify the correct HNS (LCN) for receiving a snoop. The LCD keeps track of requests from RN (e.g. in a table indexed by memory address) and can therefore route the snoop on to the correct RN.

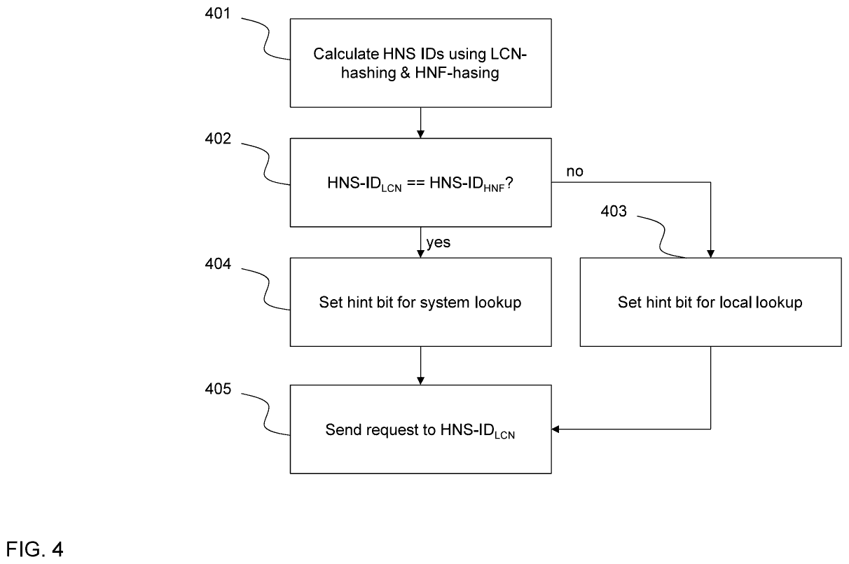

FIG. 4 illustrates logic, optionally enabled by the SAM in each RN, for implementing the first, stricter proximity condition. In a first step 401 an RN performs LCN-hashing and HNF-hashing on the memory address and performs a lookup (e.g. into a structure such as the table on the left of FIG. 3) to determine two HNS IDs. In a second step 402, the RN checks if the two HNS-IDs are equal. If they are not, the RN sets 403 the hint bit in the request for local lookup. If they are equal, the RN sets 404 the hint bit in the request for system lookup (i.e. bypassing the local lookup). Then the RN sends 405 the request to the HNS with the ID determined from the LCN-hashing (which will be the same as the ID determined from the HNF-hashing when performing the bypass).

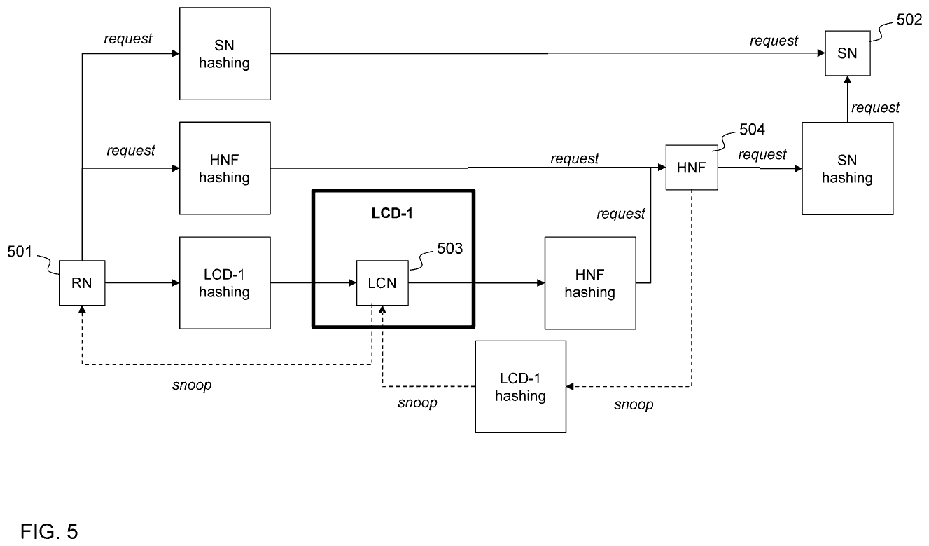

FIG. 5 illustrates the use of the same hashing mechanism for routing requests and snoops, in an example system. An RN 501 in an LCD (e.g. LCD-1 in this example) can send a non-coherent request directly to an SN 502, where no caching is required, by using the SN-hashing process. The default behaviour of the RN 501 for a coherent request is to use LCN-hashing to identify a target ID of an HNS 503 within LCD-1 (i.e. applying the LCD-1 offset to the LCN-hashing result) for receiving the request for local-coherency cache lookup. The RN 501 sets the hint bit to indicate local lookup and so this HNS 503 uses its LCN component to perform a lookup. If this misses, the HNS (LCN) 503 performs HNF-hashing to identify the unique system-level HNS 504 that is associated with the memory address, and sends the request on to the HNS 504 with the hint bit set for system-level lookup. It also adds an entry to the snoop filter of LCD-1, identifying the RN 501 against the cache line. This HNS 504 uses its HNF component to perform a lookup. If this misses, the HNS (HNF) 504 in this example uses SN-hashing to identify the SN 502 that is associated with the memory address, and sends the request on to the SN 502 for a memory access.

When routing a snoop back to the RN 501, the HNS (HNF) 504 knows, from the request, which LCD to send the snoop to, but not which LCN within LCD-1 to send it to. It also does not know the identity of the RN. The HNS 504 therefore uses the cache-line memory address to perform the same LCN-hashing operation to determine the target ID of the HNS 503, and send the snoop to this node. The HNS (LCN) 503 uses the snoop filter of LCD-1 to determine the ID of the RN 501, and uses this to route the snoop back to the RN 501.

For broadcast snoops, an HN sends snoops to all the LCDs, which use the SAM to perform different hashing operations to determine the LCN node within each LCD to receive the snoop.

In multi-chip configurations, two chips can be coupled by respective cross-chip gateways (CCGs). These may be grouped into a number of different cross-chip-gateway port aggregation groups (CPAGs) on a chip. In order to reduce the interconnect latencies on requests and snoops, each LCD on a chip is affinitized to a closest one of the CPGAs on the chip. Closeness here may be determined in accordance with a proximity metric. This may depend upon latency, or upon physical proximity, or upon a number of routers along a path from the LCD to each CPGA, or may be determined in any other suitable way. Each HNF tracks remote (i.e. off-chip) LCDs with a unique CPAG to limit the snoop traffic targeting a particular LCD.

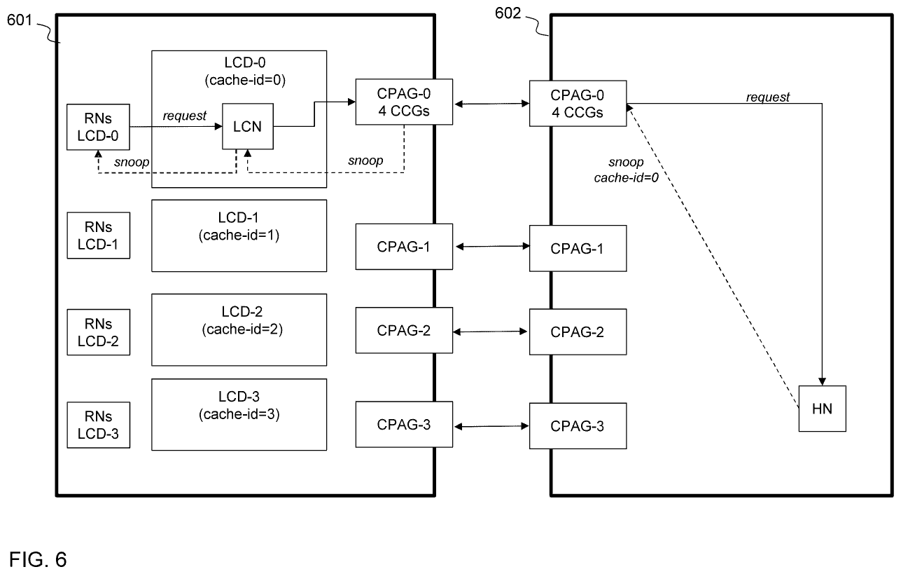

FIG. 6 illustrates this for a first chiplet 601 that is communicably coupled to a second chiplet 602 by four CPAGs, each containing four CCGs. Within the first chiplet 601, an exemplary RN in an exemplary LCD (e.g. LCD-0) sends a request to an HNS (LCN) for a cache line on the second chiplet 602. The local-cache lookup misses in this example, and the request is forwarded to the unique HNS (HNF) on the second chiplet 602 that handles that memory address for the system-level caching. The second chiplet 602 is configured to route snoop is routed back to the same CCG. This is beneficial, when intermediate nodes enable early write completions, for improving the performance resulting in the copyback(write)-snoop hazarding at these intermediate nodes. Since there is probability of the copybacks and snoops hazarding during the operation, it is desirable that they go through the same CCG. This is achieved by the HN tracking the remote LCD from which a request is received and using this to direct the snoop to the same CCG.

Various embodiments described herein are implemented using dedicated hardware, configurable hardware or programmed processors executing programming instructions that are broadly described in flow chart form that can be stored on any suitable electronic storage medium or transmitted over any suitable electronic communication medium. A combination of these elements may be used. Those skilled in the art will appreciate that the processes and mechanisms described above can be implemented in any number of variations without departing from the present disclosure. For example, the order of certain operations carried out can often be varied, additional operations can be added, or operations can be deleted, without departing from the present disclosure. Such variations are contemplated and considered equivalent.

The various representative embodiments, which have been described in detail herein, have been presented by way of example and not by way of limitation. It will be understood by those skilled in the art that various changes may be made in the form and details of the described embodiments resulting in equivalent embodiments that remain within the scope of the appended claims.

Concepts described herein may be embodied in computer-readable code for fabrication of an apparatus that embodies the described concepts. For example, the computer-readable code can be used at one or more stages of a semiconductor design and fabrication process, including an electronic design automation (EDA) stage, to fabricate an integrated circuit comprising the apparatus embodying the concepts. The above computer-readable code may additionally or alternatively enable the definition, modelling, simulation, verification and/or testing of an apparatus embodying the concepts described herein.

For example, the computer-readable code for fabrication of an apparatus embodying the concepts described herein can be embodied in code defining a hardware description language (HDL) representation of the concepts. For example, the code may define a register-transfer-level (RTL) abstraction of one or more logic circuits for defining an apparatus embodying the concepts. The code may define an HDL representation of the one or more logic circuits embodying the apparatus in Verilog, SystemVerilog, Chisel, or VHDL (Very High-Speed Integrated Circuit Hardware Description Language) as well as intermediate representations such as FIRRTL. Computer-readable code may provide definitions embodying the concept using system-level modelling languages such as SystemC and SystemVerilog or other behavioural representations of the concepts that can be interpreted by a computer to enable simulation, functional and/or formal verification, and testing of the concepts.

Additionally or alternatively, the computer-readable code may define a low-level description of integrated circuit components that embody concepts described herein, such as one or more netlists or integrated circuit layout definitions, including representations such as GDSII. The one or more netlists or other computer-readable representation of integrated circuit components may be generated by applying one or more logic synthesis processes to an RTL representation to generate definitions for use in fabrication of an apparatus embodying the disclosure. Alternatively or additionally, the one or more logic synthesis processes can generate from the computer-readable code a bitstream to be loaded into a field programmable gate array (FPGA) to configure the FPGA to embody the described concepts. The FPGA may be deployed for the purposes of verification and test of the concepts prior to fabrication in an integrated circuit or the FPGA may be deployed in a product directly.

The computer-readable code may comprise a mix of code representations for fabrication of an apparatus, for example including a mix of one or more of an RTL representation, a netlist representation, or another computer-readable definition to be used in a semiconductor design and fabrication process to fabricate an apparatus embodying the disclosure. Alternatively or additionally, the concept may be defined in a combination of a computer-readable definition to be used in a semiconductor design and fabrication process to fabricate an apparatus and computer-readable code defining instructions which are to be executed by the defined apparatus once fabricated.

Such computer-readable code can be disposed in any known transitory computer-readable medium (such as wired or wireless transmission of code over a network) or non-transitory computer-readable medium such as semiconductor, magnetic disk, or optical disc. An integrated circuit fabricated using the computer-readable code may comprise components such as one or more of a central processing unit, graphics processing unit, neural processing unit, digital signal processor or other components that individually or collectively embody the concept.

It will be appreciated by those skilled in the art that the disclosure has been illustrated by describing one or more specific embodiments thereof, but is not limited to these embodiments; many variations and modifications are possible within the spirit and scope of the disclosure.

We claim:

1. An integrated-circuit apparatus comprising:
a first plurality of coherency nodes configured to provide a distributed system-level cache, wherein each of the plurality of coherency nodes is configured to provide system-level caching for a respective set of memory addresses allocated to the coherency node; and
a requestor node;
wherein:
the first plurality of coherency nodes, or a second plurality of coherency nodes, is configured to provide respective distributed local coherency caches for a set of local coherency domains, wherein each of the coherency nodes of the first or second plurality is configured to provide local coherency caching for a respective set of memory addresses allocated to the coherency node;
the apparatus is configured to assign the requestor node and each coherency node to a respective local coherency domain of the set of local coherency domains;
the requestor node is configured to send a first memory request to a coherency node, in a same local coherency domain as the requestor node, for local-coherency-cache lookup; and
the requestor node is further configured to send a second memory request to a coherency node, in a same local coherency domain as the requestor node, for system-level-cache lookup without first sending the second memory request to a coherency node for local-coherency-cache lookup.

2. The integrated-circuit apparatus of claim 1, wherein the requestor node is configured to determine whether a memory request is for a memory address that is allocated to a coherency node for system-level caching that is in a same local coherency domain as the requestor node, and is configured to send a memory request to the coherency node for system-level-cache lookup, without first sending the memory request for local-coherency-cache lookup, in response to determining that the memory request is for a memory address that is allocated to a coherency node for system-level caching that is in a same local coherency domain as the requestor node.

3. The integrated-circuit apparatus of claim 1, wherein each coherency node provides system-level caching and local coherency caching, and wherein the requestor node is configured to determine whether a memory request is for a memory address that is allocated to a coherency node, in a same local coherency domain as the requestor node, for local-coherency caching and for system-level caching, and is configured to send the memory request to the coherency node for system-level-cache lookup, without first sending the memory request for local-coherency-cache lookup, in response to determining that the memory request is for a memory address that is allocated to a coherency node, in a same local coherency domain as the requestor node, for local-coherency caching and for system-level caching.

4. The integrated-circuit apparatus of claim 3, wherein the requestor node is configured to set a flag within the memory request to indicate whether the memory request is to be processed by the coherency node for system-level-cache lookup or for local-coherency-cache lookup.

5. The integrated-circuit apparatus of claim 1, wherein each of the coherency nodes that are configured to provide local-coherency caching is further configured, in response to a cache-line miss for a respective memory request received for local-coherency-cache lookup, to send the memory request to a coherency node for system-level-cache lookup.

6. The integrated-circuit apparatus of claim 5, wherein each of the coherency nodes is further configured to set a flag within the respective memory request to indicate that the memory request is to be processed for system-level-cache lookup.

7. The integrated-circuit apparatus of claim 1, wherein:
each of the coherency nodes is associated with a respective node identifier;
the requestor node is configured to determine, from any of a set of memory addresses, a respective first node identifier for system-level-cache lookup and a respective second node identifier for local-coherency-cache lookup; and
the requestor node is configured to use the respective first and second node identifiers determined from a memory address to determine whether to send a memory request for the memory address to a coherency node for system-level-cache lookup without first sending the memory request for local-coherency-cache lookup.

8. The integrated-circuit apparatus of claim 7, wherein the requestor node is configured, when determining the first node identifier, to apply a first hash function to the memory address, and is configured, when determining the second node identifier, to apply a second hash function, different from the first hash function, to the memory address.

9. The integrated-circuit apparatus of claim 7, wherein each of the coherency nodes is configured to determine the respective second node identifier from any of a set of memory addresses, and to direct a snoop, associated with a memory address, to a coherency node associated with the respective second node identifier.

10. The integrated-circuit apparatus of claim 7, further comprising one or more memory-controller or bridge nodes, each associated with a respective node identifier, wherein the requestor node is further configured to determine, from any of the set of memory addresses, a respective third node identifier, and is configured to send a direct-access or prefetch request for a memory address to a memory-controller or bridge node associated with the respective third node identifier without first sending the request to a coherency node.

11. The integrated-circuit apparatus of claim 1, wherein the integrated-circuit apparatus is configured, for each of the local coherency domains, to track requestor nodes, associated with memory requests, in a respective local-coherency-cache snoop filter for the local coherency domain, and is further configured to track local coherency domains, associated with memory requests, in a system-level-cache snoop filter.

12. The integrated-circuit apparatus of claim 1, wherein the requestor node and first plurality of coherency nodes are provided by a first integrated-circuit chip, wherein the first integrated-circuit chip comprises a plurality of cross-chip gateway-port aggregation groups for communication with one or more further integrated-circuit chips, and wherein each of the local coherency domains is affinitized to a closest cross-chip gateway-port aggregation group of the plurality of cross-chip gateway-port aggregation groups.

13. The integrated-circuit apparatus of claim 1, wherein the assignment of the requestor node and each of the coherency nodes to a respective local coherency domain is configurable and depends at least in part upon configuration data stored in a configuration memory of the integrated-circuit apparatus.

14. The integrated-circuit apparatus of claim 13, wherein a total number of local coherency domains provided by the integrated-circuit apparatus in operation is configurable and depends at least in part upon the configuration data stored in the configuration memory.

15. A method of operating an integrated-circuit apparatus, wherein the integrated-circuit apparatus comprises:
a first plurality of coherency nodes providing a distributed system-level cache, wherein each of the plurality of coherency nodes provides system-level caching for a respective set of memory addresses allocated to the coherency node; and
a requestor node,
wherein:
the first plurality of coherency nodes, or a second plurality of coherency nodes, provides respective distributed local coherency caches for a set of local coherency domains;
each coherency node provides local coherency caching for a respective set of memory addresses allocated to the coherency node; and
the requestor node and each coherency node is assigned to a respective local coherency domain of the set of local coherency domains, the method comprising:
the requestor node sending a first memory request to a coherency node, in a same local coherency domain as the requestor node, for local-coherency-cache lookup; and
the requestor node sending a second memory request to a coherency node, in a same local coherency domain as the requestor node, for system-level-cache lookup without first sending the second memory request to a coherency node for local-coherency-cache lookup.

16. The method of claim 15, further comprising:
the requestor node determining that the first memory request is for a memory address that is allocated to a coherency node for system-level caching that is not in a same local coherency domain as the requestor node, and performing the sending of the first memory request for local-coherency-cache lookup in response thereto; and
the requestor node determining that the second memory request is for a memory address that is allocated to a coherency node for system-level caching that is in a same local coherency domain as the requestor node, and performing the sending of the second memory request for system-level-cache lookup in response thereto.

17. The method of claim 15, wherein each coherency node provides system-level caching and local coherency caching, the method further comprising:
the requestor node determining that the first memory request is for a memory address that is allocated to a first coherency node, in a same local coherency domain as the requestor node, for local-coherency caching and that is allocated to a second coherency node, different from the first coherency node, for system-level caching, and performing the sending of the first memory request for local-coherency-cache lookup in response thereto; and
the requestor node determining that the second memory request is for a memory address that is allocated to a coherency node, in a same local coherency domain as the requestor node, for local-coherency caching and for system-level caching, and performing the sending of the second memory request for system-level-cache lookup in response thereto.

18. The method of claim 15, wherein each of the coherency nodes is associated with a respective node identifier, the method further comprising:
the requestor node determining, from the memory address of the first memory request, a first node identifier for system-level-cache lookup and a second node identifier for local-coherency-cache lookup; determining that the second node identifier does not equal the first node identifier; and, in response thereto, sending the first memory request to the coherency node associated with the second node identifier for local-coherency-cache lookup; and
the requestor node determining, from the memory address of the second memory request, a third node identifier for system-level-cache lookup and a fourth node identifier for local-coherency-cache lookup; determining that the third node identifier equals the fourth node identifier; and, in response thereto, sending the second memory request to the coherency node associated with the third node identifier for system-level-cache lookup without first sending the second memory request for local-coherency-cache lookup.

19. The method of claim 18, further comprising a coherency node receiving a snoop, associated with the memory address of the first memory request; determining the second node identifier from the memory address; and directing the snoop to the coherency node associated with the second node identifier.

20. A non-transitory computer-readable medium storing computer-readable code for fabrication of the integrated-circuit apparatus of claim 1.
